(19) United States
(12) Patent Application Publication
(10) Pub. No.: US 2010/0308192 A1
(43) Pub. Date: Dec. 9, 2010

(54) SENSOR ATTACHMENT ARRANGEMENT

(75) Inventors: Joachim Spratte, Osnabruck (DE); Michael Schwab, Markdorf (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/864,884

(22) PCT Filed: Jan. 31, 2008
(86) PCT No.: PCT/DE08/50041

§ 371 Date: Jul. 28, 2010

(30) Foreign Application Priority Data
Jan. 31, 2008 (DE) 10 2008 007 106.4

(51) Int. Cl. F16M 13/02; F16M 13/00

(52) U.S. Cl. 248/224.8; 248/309.1

(57) ABSTRACT

A sensor attachment arrangement with a sensor holder (3) for attachment to a component (6) to which at least one sensor (2) is attached or can be attached. The sensor holder (3) has at least a finger-shape mounting element (4) with a cavity (7) therein in which a strut (8) is received such that by insertion of the strut (8), the mounting element (4) is splayed or can be spread at least in some areas to secure the sensor holder (3) to the component (6).

This application is a National Stage completion of PCT/DE2008/050041 filed Dec. 10, 2008, which claims priority from German patent application serial no. 10 2008 007 106.4 filed Jan. 31, 2008.

### FIELD OF THE INVENTION

The invention relates to a Sensor Attachment Arrangement with a provided sensor holder for the attachment to a part in which at least one sensor is attached or can be attached.

### BACKGROUND OF THE INVENTION

Sensors usually convert mechanical parameters into electric signals. Hereby, the signals have to be positioned and specified in a suitable manner for the dimensional scaling. This happens usually by positioning the sensor in a housing (for instance with glue, clamps, encapsulating, or insert molding), and the housing is later attached to the complete system. This can again be accomplished for instance through screws, glue, welding, or riveting.

Known through DE 198 31 248 C2 is a sensor assembly in a suspension for a vehicle, whereby the swivel arm is pivotally mounted. A sensor for the detection of the relative position between the swivel arm and the vehicle body is fixed at the vehicle body and mechanically coupled with the swivel arm. A sensor coupling, sensor bracket and a swivel bearing of the swivel arm, through which the swivel arm is pivotally mounted to the vehicle body, are attached in a common mounting location at the body of the vehicle.

The disadvantages of the known mounting methods are, for instance, costly positioning and attachment processes (welding, gluing, etc) or the occurrance of mechanical tensions in the sensor system, which result in measuring errors or damages.

### SUMMARY OF THE INVENTION

Based on these findings, it is the task of the invention to further advance the previously mentioned Sensor Attachment Arrangement, so that the sensor holder can be positioned and fixed in a simple way at a periphery, like for instance at a component part, without any exposure of tension to the sensor.

The inventive sensor attachment arrangement, suitable especially for a motor vehicle, provides a sensor holder for the attachment to a component, in which at least one sensor is attached or can be attached, whereby the sensor holder has a finger-like mounting element with a hole, in which a strut is displaceably positioned, and whereby the mounting element splays or can be splayed in certain areas through a displacement of the strut.

If the mounting element is inserted into the opening of a component and then splayed through the displacement of the strut, the mounting element can be force fitted and/or form-locked to the component. The sensor holder can be positioned hereby prior to the splaying. After the splaying, the sensor holder sits firmly at the component, whereby, due to the splaying, tensions in the mounting element are not, or just slightly transferred to the remaining component of the sensor holder, so that the tensions have no or just a negligible influence regarding the sensor and its position.

The Sensor Attachment Arrangement comprises preferably of a component, provided with an opening, into which the mounting element is placed. The positioning and the following attachment of the mounting element to the component can then take place as described above. The opening in the component can be limited to a single side and, for instance, can be designed as a blind hole. This option, however, can represent a low tolerance manufacturing and therefore can be expensive to manufacture the opening. It is preferred to have the opening as a continuous opening, especially a breakthrough where the mounting element extends through it. For the positioning and prior to the splaying, the mounting element is preferably adjustable and rotatable. Hereby, an option is created to manufacture the surface of the component and/or the diameter of the opening as non-sensitive to tolerances, whereby the cost of manufacturing for the component can be reduced. In particular, the mounting element can be positioned in the opening in up to five degrees of freedom, and can then be attached at the component in a sixth degree of freedom, which usually coincides with the insertion direction into the opening of the mounting element. The up to five degrees of freedom comprise, for instance, four translational and one rotary degrees of freedom. The sixth degree of freedom is especially a translational degree of freedom.

In accordance with an additional embodiment, the component is presented as a suspension component of a motor vehicle. In particular, the component is presented as a suspension arm, like, for instance, as a transverse link. In addition or as an alternative, the component is or can be a ball joint and/or a part of a ball joint, like for instance a cover of a ball joint, or a ball joint enclosure. It is also possible that the component is a suspension arm which has at least one ball joint. For instance, the sensor can be used to determine the relative position of the ball pin of the ball joint in relationship to the suspension arm, to the cover, and/or to the ball joint enclosure.

There are several options available to attach the sensor holder at the component through the spread mounting element. First, it is possible that the mounting element when splayed presses against the wall which borders the opening and it is hereby frictionally locked attached to it. Also, as an alternative, it is possible that the splayed mounting element extends beyond the head edge to the outside of the opening and vertical to its longitudinal direction and is therefore form locked with the component. Form locking can fix the mounting element, in the axial direction, with either a single side or with both sides to the component. In accordance with a preferred embodiment, the splayed mounting element extends therefore to the outside of the opening, and vertically to its longitudinal direction, on both sides of the opening and beyond the head edges of the opening and is hereby form locked to the component. Additionally or alternatively is it possible that the wall of the component which bounds the opening, has at least one return notch which latches into the splay mounting element. The return notch is designed in particular as ring-shaped.

The mounting element can be designed cylindrically. Alternatively, the mounting element can also have any other geometric shape which corresponds with the opening in the component. In particular, the opening is matched to the geometry of the mounting element. If the mounting element is, in its cross section, circular or elliptical, the opening is preferably, in its cross section, circular or elliptical. If the mounting element has a triangular or polygonal cross section, the opening is also preferably, in its cross section, triangular or polygonal.

The sensor holder can be designed with a stop which, in particular, extends away from the sensor holder in the same direction as the mounting element. Preferably, the stop is positioned in a distance to the mounting element and it rests, in the installed condition, on the surface of the component. Hereby, positioning of the sensor holder is made easier because, due to the stop, a degree of freedom is determined or can be determined.

In accordance with an embodiment, the sensor holder can be mounted, at a distance to the mounting element, at a protrusion of the component which is attached to the component or is designed with the protrusion as one piece. In particular, the sensor holder has hereby a recess which latches into the protrusion of the component or it can latch with the protrusion of the component. The protrusion and the sensor holder, or the recess, respectively, form together a snap connection. In particular, the sensor holder is rotatable mounted at the protrusion so that a positioning of the sensor holder, relative to the component, is possible. However, rotation of the sensor holder around the protrusion can be limited by the fact that the mounting element touches the wall, bordering the opening, of the component.

The component is preferably a suspension arm with a ball joint which is designed with the protrusion. In particular, the ball joint comprises a closure cover which is formed by the protrusion or which possesses the protrusion. The closure cover is preferably a part of the enclosure of the ball joint, whereby the ball joint enclosure is firmly connected with the suspension arm or they are designed as a single piece. The opening can be provided in the closure cover, in the ball joint enclosure, or in the suspension arm.

Prior to the slaying, the strut preferably protrudes out of the mounting element so that it is easily accessible for the displacement. Also, the mounting element is splayed preferably by the insertion of a strut into the hole. After splaying, the strut can be positioned completely in the mounting element, or partially and, for instance, with a head protruding out of the mounting element. The latter is advantageous when the sensor holder needs again to be detached from the component.

Before splaying, the hole has, transverse to its longitudinal direction, in at least one area, a smaller geometric dimension than after splaying in that area of the strut. This can be for instance realized when the wall of the mounting element, bordering the hole, has at least a constriction which narrows the hole, so that the strut, during insertion into the hole, expands at least a constriction, which leads to the splay of the mounting element. Preferred hereby is that the clear width of at least one constriction, prior to splaying, is smaller than the geometric, outer dimension, in particular, that outer diameter of that part of the strut which is positioned, after the splay, in the widened constriction. The constriction is formed in particular through one or more arched areas in the wall, bordering the hole, of the mounting element. Preferred is an increased thickness of the wall of the mounting element, which bounds the hole, in the area of at least the one constriction.

The strut, in the splayed condition of the mounting element, is preferably locked in place with it. In particular, the strut has at least one recess on its outer surface, into which a provided latching neck, located on the wall which bounds the hole, either latches or can latch. The latching neck comprises, for instance, at least one locking protrusion at the wall of the mounting element which bounds the hole. The recess is preferably provided at the end area of the strut, through which the strut is first inserted into the hole. In particular, the recess is provided at the end area of the strut which faces the sensor holder.

The hole extends preferably in the longitudinal direction of the mounting element. Also, the hole can extend vertically in reference to this longitudinal direction, at least in partial areas throughout the mounting element. It is therefore possible to create at least a part of the hole with its required inner geometry for the splay in a simple way, for instance through stamping.

The sensor holder is preferably an enclosure for at least one sensor, so that the sensor is protected from environmental impacts.

Preferably, the sensor holder is made from plastic. Also, the mounting element and/or the strut are constructed from plastic. As an alternative, for the sensor holder, for the mounting element, and/or for the strut other material can be used, for instance metal. The component is preferably constructed from metal, from plastic, or from a combination of the materials.

Fixing and positioning the sensor holder and/or at least the one sensor takes place preferably via a finger-like element (mounting element) which is inserted into an opening, for instance designed as a breakthrough, which is incorporated into the periphery (component). This finger (mounting element) can be, for instance, cylindrically constructed. The finger can also adopt any other geometrical shape which corresponds with the opening in the periphery component (component). Through displacement of the strut, which resides in the finger, a portion of the finger is geometrically deformed, so that a form lock and/or traction lock is created. Hereby, the sensor holder which is, in particular, designed as a sensor enclosure can be, dependent of the embodiment, positioned in up to five degrees of freedom and later fixed in six degrees of freedom. The sixth degree of freedom of the positioning is hereby usually the insertion direction of the finger into the opening. Positioning in this direction can take place through a stop which can also be positioned externally in reference to the opening.

Due to the low-force or nearly force-free installation of the sensor at the periphery with tension following thereafter which is caused by the plastic the formation, it is possible to mount the sensor mechanically, without tension, at the periphery. Especially advantageous is the design of the finger and of the strut through plastic material, but basically, the use of a metallic material is also suitable. An especially robust connection is achieved when the strut, at the end of the insertion path, is also mechanically locked into place. Also, the possibility exists to provide the Sensor Attachment Arrangement with an additional fastening function as a twist protection. Hereby, the sensor holder or sensor, respectively, is installed on a cylindrical part (protrusion) of the periphery, having a twist degree of freedom, for instance through clipping. The finger serves, in this case, as a twist protection which dips into the opening of the periphery, at a distant place of the cylindrical part, and is fixed there.

### BRIEF DESCRIPTION OF THE DRAWINGS

In the following, the invention is described based on preferred embodiments by referencing the drawing. In the drawing is shown:

FIG. 1 a partial section view of a Sensor Attachment Arrangement in accordance with a first embodiment of the invention, prior being splayed;

FIG. 2 a partial section view of the first embodiment after being splayed;

FIG. 3 a bottom view of the first embodiment;

FIG. 4 a partial section view of a Sensor Attachment Arrangement in accordance with the second embodiment of the invention, after being splayed;

FIG. 5 a bottom view of a Sensor Attachment Arrangement in accordance with a third embodiment of the invention;

FIG. 6 a section view of a Sensor Attachment Arrangement in accordance with a fourth embodiment of the invention; and

FIG. 7 a partial section side view of a Sensor Attachment Arrangement in accordance with the fifth embodiment of the invention.

### DETAILED DESCRIPTION OF THE PREFERRED EMBODIMENTS

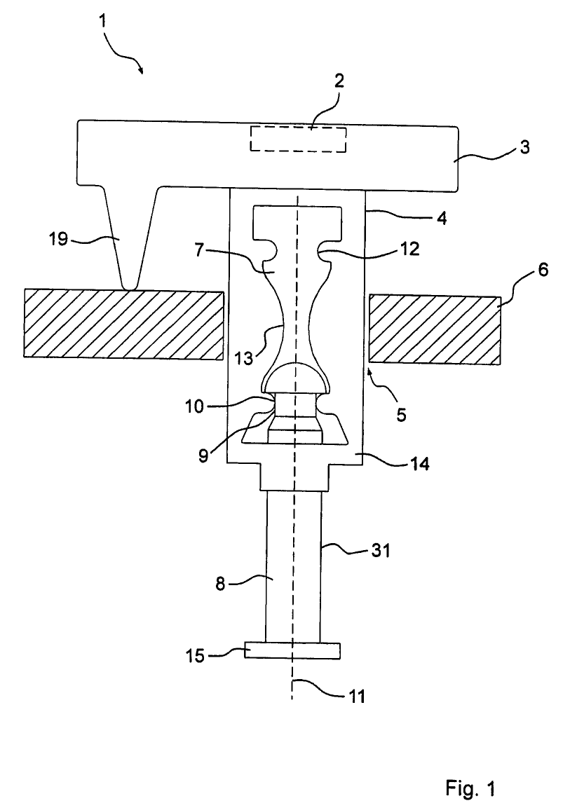

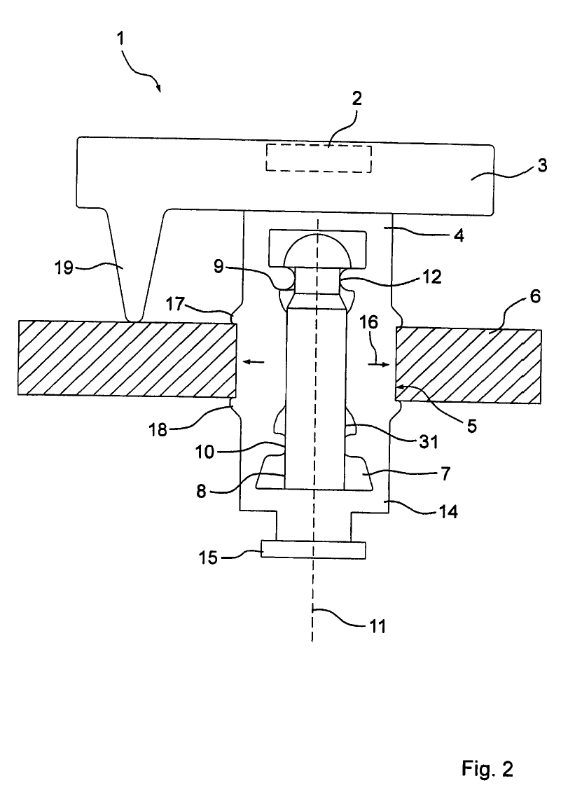

From FIG. 1, a side view of a Sensor Attachment Arrangement 1, in accordance with a first embodiment of the invention, can be seen, whereby the sensor 2 is attached at a sensor holder 3, which has a finger-like mounting element 4, which extends through an aperture 5 in a component 6, which is presented in a sectional view. The mounting element 4 shows a cavity 7, into which a strut 8 is inserted. The cavity 7 is essentially cylindrically designed and has at its end region, into which the strut 8 is inserted, a latching constriction 10 in the bounding wall of the mounting element 4 that catches in a recess 9, so that the strut 8 is secured in the mounting element 4. The longitudinal direction 11 of the cavity 7 also establishes the longitudinal direction of the mounting element 4 and of the aperture 5. In addition, the strut 8 can be inserted into the cavity 7 in the longitudinal direction 11. The wall of the mounting element 4, which bounds the cavity 7, has an additional latching constriction 12 which, in the inserted condition of the strut 8, latches with the recess 9 (see FIG. 2). The two latching constrictions 10 and 12 comprise, in accordance with this embodiment, each a pair of protrusions, which are provided in the wall of the mounting element 4, which bounds the cavity 7.

Between the two latching constrictions 10 and 12, the wall, which bounds the cavity 7, is arched to the inside so that, in the area of this curving and perpendicular to the longitudinal direction 11, the cavity 7 has a clear width which is smaller than the outer diameter of the cylindrical area 31 of the strut 8. The wall, which bounds the cavity 7, has therefore between the two latching constrictions 10 and 12 an additional constriction 13, which becomes enlarged when the strut 8 is inserted (see FIG. 2).

The mounting element 4 has, at its free end, a frontal cover 14 through which the strut 8 extends, which has at the free end, outside of the mounting element 4, a head 15 where the diameter is larger than the diameter of the cylindrical area 31. The head 15 forms a stop which limits insertion of the strut 8 into the mounting element 4, whereby the head 15 strikes the cover 14.

FIG. 2 shows a side view of the Sensor Attachment Arrangement 1 in a condition where the strut 8 is inserted into the mounting element 4 and the head 15 resides on the cover 14. Due to the fact that, prior to the insertion of the strut 8, the mounting element 4 has in the area of the constriction 13 smaller geometrical dimensions transverse to the longitudinal direction 11 than the cylindrical area 31 of the strut 8, the mounting element 4 is now splayed, or enlarged, respectively, so that the part of the outer surface of the mounting element 4, residing in the aperture 5, presses against the wall of the component 6, which bounds the aperture 5. Hereby, a friction-lock or force-lock connection, respectively, is created between the mounting element 4 in the component 6, which is presented as a section view. The pressure which is applied through the mounting element 4 to the component 6 is indicated through arrows 16. In addition, the splay of the mounting element 4, outside of the aperture 5, creates bulges 17 and 18, which extend vertically to the longitudinal direction 11 beyond the top edges of the aperture 5. Thus, the mounting element 4 is also form-locked fixed to the component 6, in the longitudinal direction 11, meaning in reference to both orientations of the longitudinal direction 11. Also, the latching constriction 12 latches into the recess 9 of the strut 8, so that it is form-locked secured with the mounting element 4.

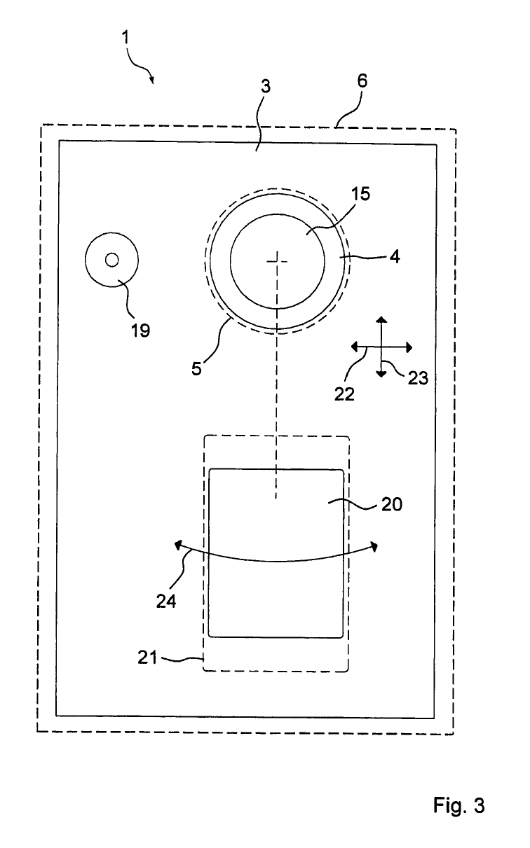

FIG. 3 is a bottom view of the Sensor Attachment Arrangement 1, whereby only a limited area of the component 6 is schematically shown. FIG. 3 shows the condition of the mounting element 4 before the insertion of the strut 8, in which between the mounting element 4 and the wall, which bounds the aperture 5 (shown as dashed line), play for the positioning of the sensor holder 3 is provided. The sensor holder 3 has a stop 19 which, in the installed condition, bears against the component 6 (see FIG. 1) and serves hereby as a positioning aid. Here, the stop 19 extends in the same direction, away from the sensor holder 3, as the mounting element 4 but it is designed to be shorter. Also, the sensor holder 3 has a (second) finger 20 which latches into a second aperture 21 which is provided with the component 6. Play exists between the finger 20 and the aperture 21, so that the sensor holder 3 can be shifted in the direction of the arrows 22 and 23. Also, the sensor holder 3 can be swiveled in the direction of the arrow 24, around the longitudinal axis 11.

The finger 20 has an essentially rectangular cross-section and therefore deviates from the circular cross-section of the mounting element 4 (first finger). Apart from it, the finger 20 can also be constructed in a related manner as the mounting element 4. In FIG. 3, the finger 20 is just a locator without an ability to splay. In accordance with an alternative of the first embodiment, the stop 19 can be omitted.

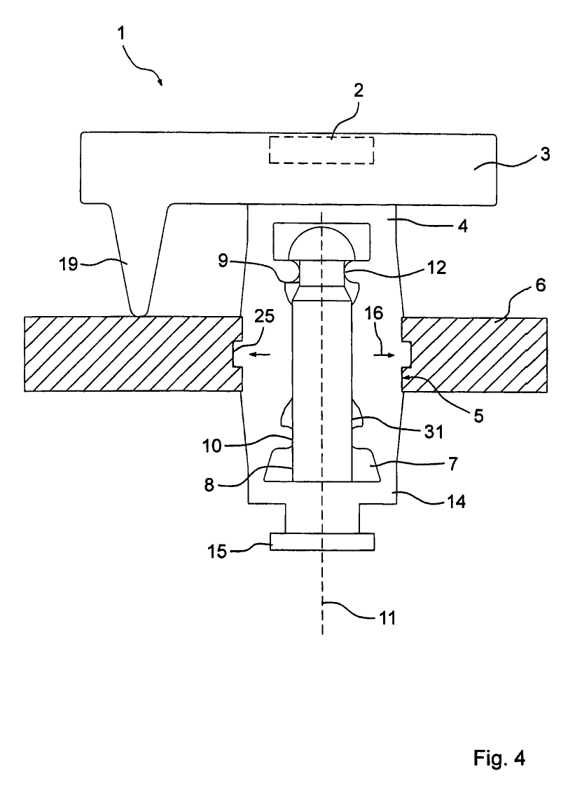

FIG. 4 shows a sectional side view of a Sensor Attachment Arrangement 1 in accordance with a second embodiment of the invention, whereby, compared to the first embodiment, similar or identical characteristics are marked with the same reference characters as in the first embodiment. Different from the first embodiment, a groove is provided in the aperture 5, into which the outer surface of the mounting element 4 latches and, therefore, secures form-locking the component 6. The bulges 17 and 18, in accordance with the first embodiment, can be omitted or can be designed smaller because the axial fixation of the mounting element 4 with the component 6, in accordance with the second embodiment, takes place exclusively or in most cases through the form-locking at the groove 25. Beside these differences, the additional description for the second embodiment is referred to as the description for the first embodiment. In accordance with an alternative of the second embodiment, the stop 19 can be omitted.

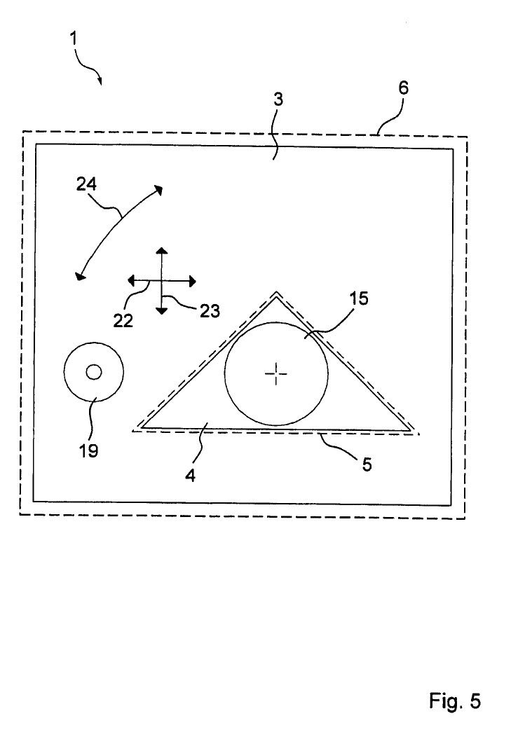

FIG. 5 shows a bottom view of the Sensor Attachment Arrangement 1, in accordance with a third embodiment of the invention, whereby, in reference to the first embodiment, similar or identical characteristics are marked with the same reference characters as in the first embodiment. Different from the first embodiment, the mounting element 4, in accordance with the third embodiment, has a triangular cross section, so that also the aperture 5 in the merely implied component 6 has a triangular cross-section. Also, the finger 20 and the aperture 21 are omitted. Finally, the strut 8 can also have a triangular cross-section, but it is also possible to use an identical strut 8 as in the first embodiment. Beside these differences, the description in the first embodiment is the reference for further descriptions of the third embodiment. In accordance to an alternative of the third embodiment, the stop 19 can be omitted.

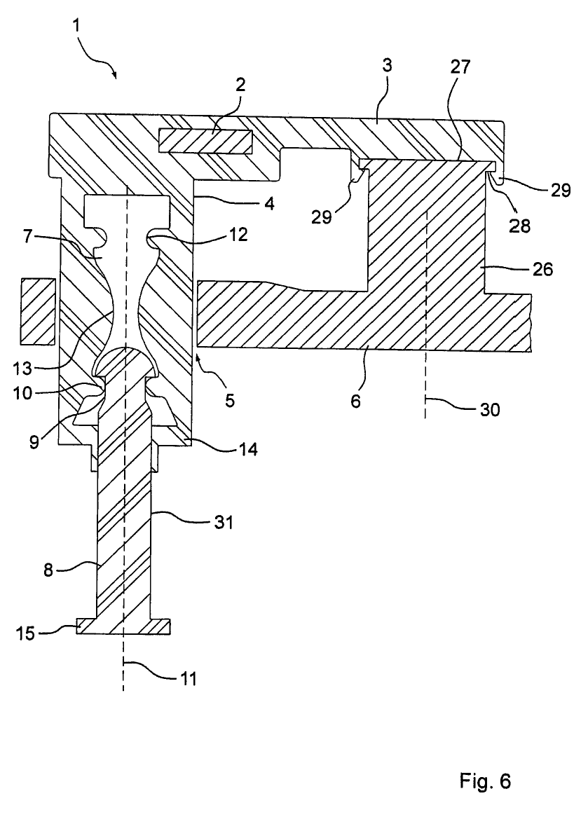

FIG. 6 shows a sectional view of a Sensor Attachment Arrangement 1 in accordance with a fourth embodiment of the invention, whereby, in reference to the first embodiment, similar or identical characteristics are marked with the same reference characters as in the first embodiment. Different from the first embodiment, the component 6 has a cylindrical protrusion 26, which latches into a provided recess 27 in the sensor holder 3, and is attached by means of a snap-in connection to the sensor holder 3. To construct the snap-in connection, the protrusion 26 has, at its end which is facing away from the component 6, a radial outer shoulder 28 which engages from behind with the provided snap-in hook 29 of the holder 3. The sensor holder 3 is mounted to rotate around the longitudinal axis 30 of the protrusion 26, whereby rotation of the sensor holder 3 around the longitudinal axis 30 is limited by the play, which the mounting element 4 has in the non-extended condition in reference to the aperture 5. The stop 19, as well as the finger 20 and the aperture 21, can be omitted. Beside these differences, the description of the first embodiment is the reference for additional descriptions of the fourth embodiment.

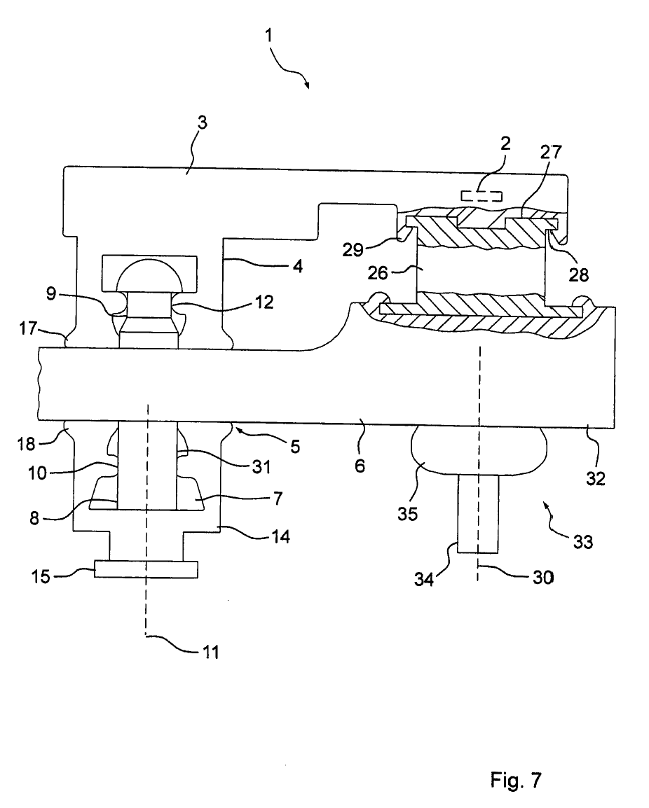

FIG. 7 shows a partial sectional side view of a Sensor Attachment Arrangement 1, in accordance with a fifth embodiment of the invention, whereby, in reference to the previous embodiments, similar or identical characteristics are marked with the same reference characters as in the previous embodiments. The fifth embodiment is a variation of the fourth embodiment, whereby the protrusion 26 is designed as a separate part and is form-locked with the component 6 which has at the shown end a ball joint enclosure 32 of a ball joint 33. The protrusion 26 forms a cover of the ball joint 33 which comprises a ball pin 34, that is rotatable and pivotally mounted in the ball joint enclosure 32. Also, a sealing bellow 35 is provided and mounted to seal the ball pin 34 and the ball joint enclosure 32. The sensor 2 serves in this case to capture the position of the ball pin 34 in reference to the component 6, which here represents in particular a suspension arm of a motor vehicle.

The protrusion 26 is a rotationally symmetrical body, in reference to the axis 30, at which the sensor holder 3 is mounted so as to pivot around the axis 30. FIG. 7 shows just the splayed condition of the mounting element 4, so that swivelling motion of the sensor holder 3 is blocked via the splayed mounting element 4 in the opening 5. The opening 5 is designed as an aperture 5 and is positioned at a distance from the ball joint enclosure 32. The descriptions of the first and the sixth embodiment are the references for further description of the fifth embodiment.

### REFERENCE CHARACTERS

1 Sensor Attachment Arrangement
2 Sensor
3 Sensor Holder
4 Mounting Element
5 Aperture/Opening in the Component
6 Component
7 Cavity in the Mounting Element
8 Strut
9 Recess
10 Latching Constriction
11 Longitudinal Direction
12 Latching Constriction
13 Constriction
14 Cover of the Mounting element
15 Strut Head
16 Pressure of the Mounting Element on the Component
17 Bulge/Deformation of the Mounting Element
18 Bulge/Deformation of the Mounting Element
19 Stop of the Sensor Holder
20 Finger at Sensor Holder
21 Aperture in the Component
22 Arrow/Positioning
23 Arrow/Positioning
24 Arrow/Positioning
25 Groove/Return Notch in the Aperture
26 Protrusion at the Component
27 Recess in Sensor Holder
28 Outer Shoulder of the Protrusion
29 Snap-In Hook at Sensor Holder
30 Longitudinal Axis of the Protrusion
31 Cylindrical Area of the Strut
32 Ball Joint Enclosure
33 Ball Joint
34 Ball Pin
35 Sealing Bellow

1-13. (canceled)

14. A sensor attachment arrangement comprising:
a sensor holder (3) for attachment with a component (6) to which at least one sensor (2) is attached,
the sensor holder (3) having at least a finger-shaped mounting element (4) with a cavity (7) therein into which a strut (8) is displaceably positioned, and
the mounting element (4), through displacement of the strut (8), being splayed at least in some areas.

15. The sensor attachment arrangement according to claim 14, wherein the component (6) has an aperture (5) through which the mounting element (4) extends.

16. The sensor attachment arrangement according to claim 15, wherein the splayed mounting element (4) presses against a wall of the aperture (5) of the component (6) and is frictionally attached to the component (6).

17. The sensor attachment arrangement according to claim 15, wherein the splayed mounting element (4) extends, outside of the aperture (5) and vertically in a longitudinal direction (11), above a top edge of the aperture (5) so as to form-lockingly attach to the component (6).

18. The sensor attachment arrangement according to claim 15, wherein the splayed mounting element (4) extends, outside of the aperture (5) and vertically in a longitudinal direction (11) on both sides of the aperture (5) so as to form-lockingly attach to the component (6).

19. The sensor attachment arrangement according to claim 15, wherein the wall of the component (6), which bounds the aperture (5), comprises at least one recess (25) into which the splayed mounting element (4) engages.

20. The sensor attachment arrangement according to claim 15, wherein the sensor holder (3) has a stop (19), at a distance from the mounting element (4), which abuts with a surface of the component (6).

21. The sensor attachment arrangement according to claim 15, wherein the sensor holder (3) has a recess (27), spaced from the mounting element (4), into which a protrusion (26) of the component (6) engages.

22. The sensor attachment arrangement according to claim 21, wherein the protrusion (26) forms, together with the recess (27), a snap lock.

23. The sensor attachment arrangement according to claim 14, wherein the mounting element (4), through insertion of the strut (8) into the cavity (7), is one of splayed and spread apart.

24. The sensor attachment arrangement according to claim 14, wherein before being splayed the cavity (7) has, along a longitudinal direction (11) thereof, at least one area of smaller, geometric dimension than a portion of the strut (8) which is positioned in the at least one area.

25. The sensor attachment arrangement according to claim 14, wherein the strut (8), once the mounting element (4) is splayed, is locked therewith.

26. The sensor attachment arrangement according to claim 25, wherein the strut (8) has outer surface with at least one recess (9) which meshes with a provided latching constriction (12) in a wall of the cavity (7) of the mounting element (4).

27. A sensor attachment arrangement for attaching a sensor (2) to a component (6), the attachment arrangement comprising:
a sensor holder (3) which retains the sensor (2) and comprises a stop (19) that extends from a face of the sensor holder (3);
a mounting element (4) being integral with the sensor holder (3) and comprising an enclosure that extends from the face of the sensor holder (3) along a longitudinal axis (11), the enclosure having an opening at an end of the mounting element (4) remote from the sensor holder (3) and defining a cavity (7) that extends from the opening, along the longitudinal axis (11), toward the sensor holder (3), the cavity (7) having at least one annular latching constriction (10, 12) and a splay constriction (13); and
an elongate strut (8) having a recess (9) and a cylindrical portion with a diameter that is greater than a width of the cavity (7), at the splay constriction (13), such that when the mounting element (4) is inserted into an aperture (5) of the component (6) and the strut (8) is inserted into the cavity (7) through the opening, the enclosure, at the latching constriction (10, 12), engages the strut (8) within the recess (9) and the cylindrical portion of the strut (8) engages the enclosure, at the splay constriction (13), and splays the enclosure and fixes the sensor holder (3) to the component (6).
